(19) United States
(12) Patent Application Publication
(10) Pub. No.: US 2016/0306634 A1
(43) Pub. Date: Oct. 20, 2016

(54) ELECTRONIC DEVICE

(71) Applicants: Inventec (Pudong) Technology Corporation, Shanghai (CN); INVENTEC CORPORATION, Taipei (TW)

(72) Inventors: Xiao-Bing ZOU, Shanghai (CN); Lei LIANG, Shanghai (CN)

(21) Appl. No.: 14/806,191

(22) Filed: Jul. 22, 2015

(30) Foreign Application Priority Data
Apr. 17, 2015 (CN) 201510186241.4

(51) Int. Cl. G06F 9/44

(52) U.S. Cl. CPC G06F 9/4401

(57) ABSTRACT

An electronic device for a micro server is provided. The electronic device includes a plurality of computer boards connected to a base board. Each of the plurality of computer boards includes a BIOS module, a first SOC, a second SOC, a logic module, a managing module, a PHY, and a first connecting interface. The BIOS module is for storing a BOIS. The first and second SOCs are for processing data. The logic module is connected to the first SOC, the second SOC, and the BIOS module respectively, and is for controlling the first SOC and the second SOC.

### CROSS-REFERENCE TO RELATED APPLICATIONS

This non-provisional application claims priority under 35 U.S.C. §119(a) on Patent Application No. 201510186241.4 filed in China on Apr. 17, 2015, the entire contents of which are hereby incorporated by reference.

### BACKGROUND OF THE INVENTION

1. Technical Field of the Invention

The present invention relates to an electronic device, particularly to an electronic device for a micro server.

2. Description of the Related Art

Generally, a traditional server has a complete chassis, power, motherboard, storage device, and other standard component, and a chassis can contain approximately 42 servers. Due to the limitation of traditional technology, the processor is often incompatible with the old server because of the interface and the software, so that the server is difficult to upgrade during the operations and is eliminated when reaching the life expectancy. Therefore, a huge amount of available components are wasted.

Consequently, an electronic device with processors consuming lower energy and capable of the functions of a general server is needed for the new generation of servers, so that the power, the cooling resources, and the waste of the available components are reduced.

### SUMMARY OF THE INVENTION

An electronic device for a micro server includes a plurality of computer boards. The plurality of computer boards are electrically connected to a base board and each of the plurality of computer boards includes a Basic Input/Output System (BIOS), a first System on Chip (SOC), a second SOC, a logic module, a managing module, a Port Physical Layer (PHY), and a first connection interface. The BIOS module is for storing a BIOS. The first SOC is for computing data. The second SOC is for computing data. The logic module is electrically connected to the first SOC, the second SOC, and the BIOS module respectively, and is for controlling the first SOC and the second SOC. The managing module is electrically connected to the logic module, the first SOC, and the second SOC respectively. The managing module obtains an operation status message of the first SOC and/or the second SOC and manages the computer board through the logic module, the first SOC, and the second SOC. The PHY is electrically connected to the managing module and is for transferring internet data. The first connection interface is electrically connected to the first SOC, the second SOC, and a network chip respectively, and is for transferring data. When the computer board is booting, the logic module controls the first SOC to read the BIOS in the BIOS module to boot, and the first SOC sends a booting-finished message to the logic module after booting, and the logic module controls the second SOC to read the BIOS in the BIOS module to boot, and the second SOC sends a booting-finished message to the logic module after booting.

The contents of the present invention set forth and the embodiments hereinafter are for demonstrating and illustrating the spirit and principles of the present invention, and for providing further explanation of the claims.

### BRIEF DESCRIPTION OF THE DRAWINGS

The present invention will become more fully understood from the detailed description given hereinbelow and the accompanying drawings, which are given by way of illustration only and thus are not limitative of the present invention and wherein:

FIG. 1 is a functional block diagram of the computer board according to an embodiment of the present invention;

FIG. 2 is a functional block diagram of the SOC according to an embodiment of the present invention;

FIG. 3 is a functional block diagram of the managing module according to an embodiment of the present invention;

FIG. 4 is a functional block diagram of the electronic device according to an embodiment of the present invention;

FIG. 5 is a layout diagram of the computer board according to an embodiment of the present invention;

FIG. 6 is a functional block diagram of the computer board according to another embodiment of the present invention; and

FIG. 7 is a diagram of the electronic device according to an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

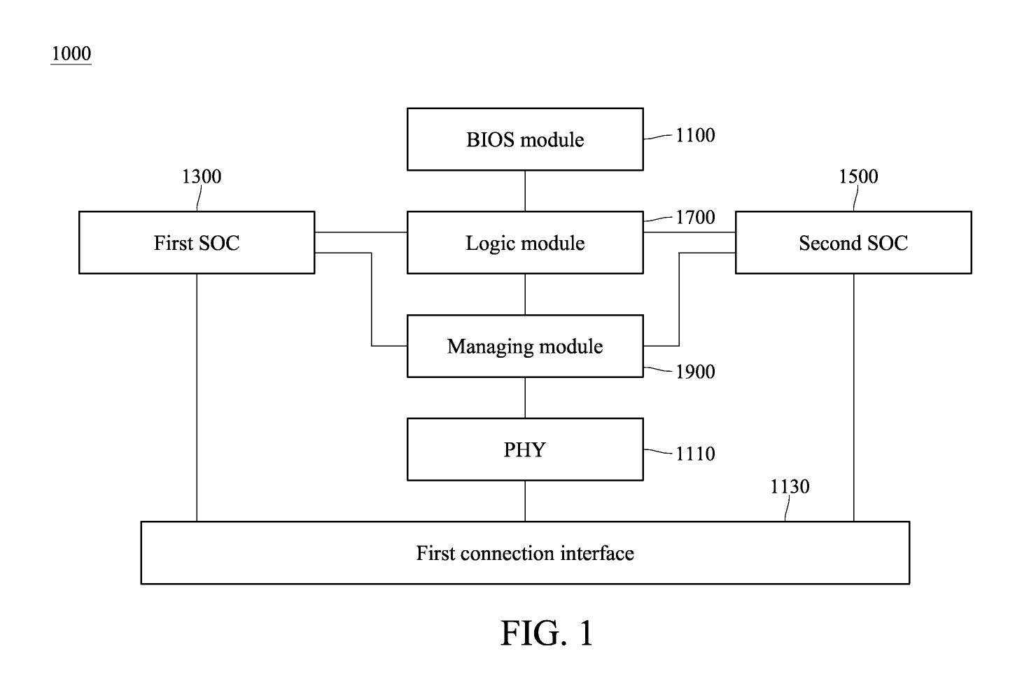

Please refer to FIG. 1. FIG. 1 is a functional block diagram of the computer board according to an embodiment of the present invention. As shown in FIG. 1, according to an embodiment, the electronic device is for a micro server. The electronic device includes a plurality of computer boards electrically connected to a base board. Each of the plurality of computer boards 1000 includes a Basic Input/Output System (BIOS) module 1100, a first SOC 1300, a second SOC 1500, a logic module 1700, a managing module 1900, a Port Physical Layer (PHY) 1110, and a first connection interface 1130.

The BIOS module 1100 is for storing a BIOS. The BIOS is for executing the self test of each part of the system when booting, activating the activation program or loading the operating system in the memory. In addition, the BIOS provides some system parameters to the operating system. In an embodiment, the BIOS module is a Read-only Memory (ROM). The embodiment is for illustrating but not for limiting the present disclosure.

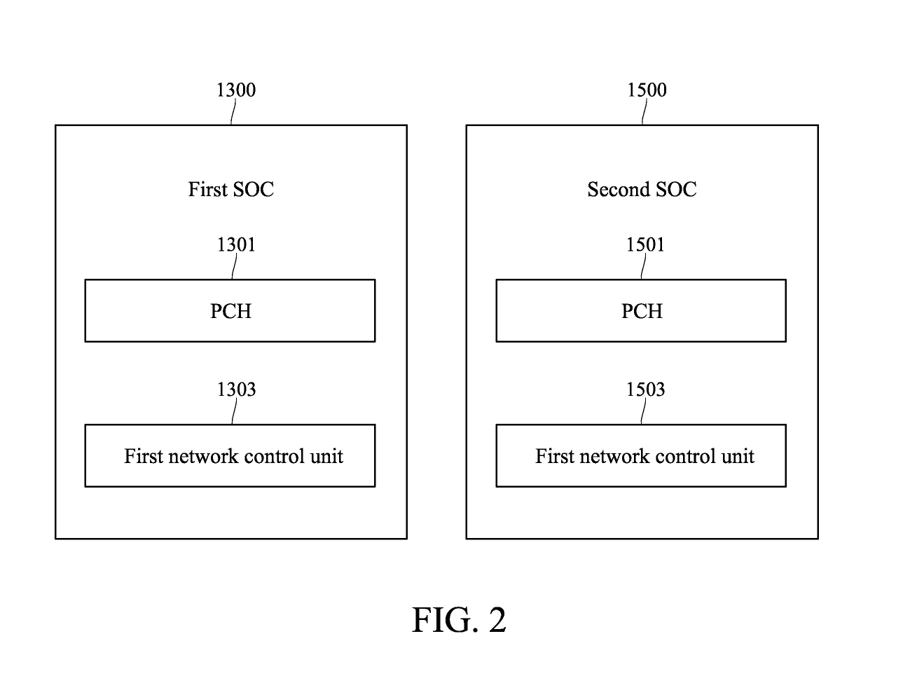

The first SOC 1300 and the second SOC 1500 are for computing data. The first SOC 1300 and the second SOC 1500 are System on Chips (SOCs) capable of computing, such as Broadwell-DE chips. Please refer to FIG. 2. FIG. 2 is a functional block diagram of the SOC according to an embodiment of the present invention. As shown in FIG. 2, the first SOC 1300 includes a Platform Controller Hub (PCH) 1301 and at least one first network control unit 1303. The second SOC 1500 includes a PCH 1501 and at least one first network control unit 1503. In an embodiment, every SOC implemented by a SOC is embedded with two 10G network controller for transferring data. The embodiment is for illustrating but not for limiting the present disclosure.

Please refer to FIG. 1 again. The logic module 1700 is electrically connected to the first SOC 1300, the second SOC 1500, and the BIOS module 1100 respectively. The logic module 1700 is for controlling the first SOC 1300 and the second SOC 1500. In an embodiment, the logic module 1700 is but not limited to complex programmable logic device (CPLD), field programmable gate array (FPGA), 8051 single chip, or any other component capable of performing logic operations.

The PHY 1110 is electrically connected to the managing module 1900 and is for transferring network data. The PHY 1110 sends and receives the Ethernet data frames or frames. Specifically, the PHY 1110 converts the signals or messages sent from the managing module 1900 to the frames conforming to the Ethernet format according to the Ethernet protocol, and then the PHY 1110 sends the signals or messages sent from the managing module 1900 through Ethernet. When the PHY 1110 receives the frames from Ethernet, the PHY 1110 explains the frames according to the Ethernet protocol and obtains the signals or messages in the frames and sends the signals or messages to the managing module 1900.

The first connection interface 1130 is electrically connected to the first SOC 1300, the second SOC 1500, and the PHY 1110 respectively for transferring data.

The managing module 1900 is electrically connected to the logic module 1700, the first SOC 1300, and the second SOC 1500 respectively. The managing module 1900 obtains the operation status message of the first SOC 1300 and/or the second SOC 1500, and the managing module 1900 manages the computer board 1000 through the logic module 1700, the first SOC 1300, and the second SOC 1500. Specifically, when the user command is sent to the managing module 1900 through the first connection interface 1130 and the PHY 1110, the managing module 1900 determines first SOC 1300 or the second SOC 1500 to execute each command and sends the command to the corresponding SOC. Meanwhile, the logic module 1700 and the managing module 1900 play the role of single bridging of the first SOC 1300 and the second SOC 1500 simultaneously or separately, so that the first SOC 1300 and the second SOC 1500 are able to perform parallel computing. In an embodiment, the managing module 1900 is a Cartridge Micro-Controller, a Micro-Controller, or any other component capable of performing logic operations. The embodiment is for illustrating but not for limiting the present disclosure.

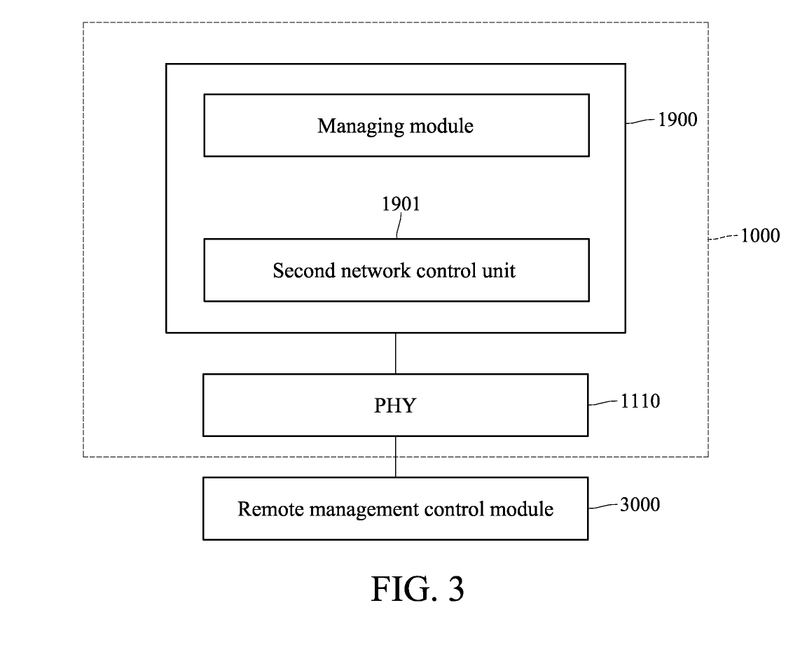

Please refer to FIG. 3. FIG. 3 is a functional block diagram of the managing module according to an embodiment of the present invention. As shown in FIG. 3, the managing module 1900 includes a second network control unit 1901. The managing module 1900 is electrically connected to the PHY 1110 through the second network control unit 1901 for communicating with a remote management control module 3000.

Please refer to FIG. 1 again. When the computer board 1000 is booted, the logic module 1700 controls the first SOC 1300 to read the BIOS in the BIOS module 1100 for booting, and the first SOC 1300 sends a booting-finished message to the logic module 1700 after booting. The logic module 1700 further controls the second SOC 1500 to read the BIOS in the BIOS module 1100 for booting, and the second SOC 1500 sends a booting-finished message to the logic module 1700 after booting.

In addition, the plurality of computer boards receive the booting command from the base board to boot, and the booting command is from the boot button electrically connected to the base board. The booting command can be also sent through Internet from the client software for booting. The first SOC 1300 and the second SOC 1500 are able to be activated individually. More specifically, the booting command is sent from the base board and received by the managing module 1900 through the PHY 1110. For example, the remote device uses Wake-on-LAN (WOL) to send the booting command to the base board thought local network, and the PHY 1110 receives the booting command from the base board and sends the booting command to the managing module 1900, and the managing module 1900 activates the SOC for booting according to the received command.

In an embodiment, the first SOC 1300 and the second SOC 1500 are further respectively electrically connected to at least one storage module and at least one memory module. The storage module is for storing data and includes disks supporting Serial Advanced Technology Attachment (SATA) or Peripheral Component Interconnect Express (PCI-E) interface. The memory module is a data storage device for the SOC during computing. The memory module is but not limited to Double-Data-Rate Three (DDR3) Synchronous Dynamic Random Access Memory.

In an embodiment, the logic module is electrically connected to a non-volatile memory, and the first SOC and the second SOC share the non-volatile memory. The first SOC and the second SOC are electrically connected to the logic module through Low pin count bus (LPC bus), Serial Peripheral Interface (SPI), and General Purpose Input Output (GPIO) to exchange information and control commands.

In addition, the managing module 1900 is electrically connected to the first SOC and the second SOC through the Inter-Integrated Circuit (IIC). The managing module is electrically connected to the logic module 1700 through input/output (I/O), SPI, and Universal Asynchronous Receiver/Transmitter (UART).

In an embodiment, the base board has a plurality of second connection interfaces and the first connection interface matches one of the plurality of second connection interfaces, and each of the plurality of computer boards is electrically connected to the base board through the first connection interface and the plurality of second connection interfaces.

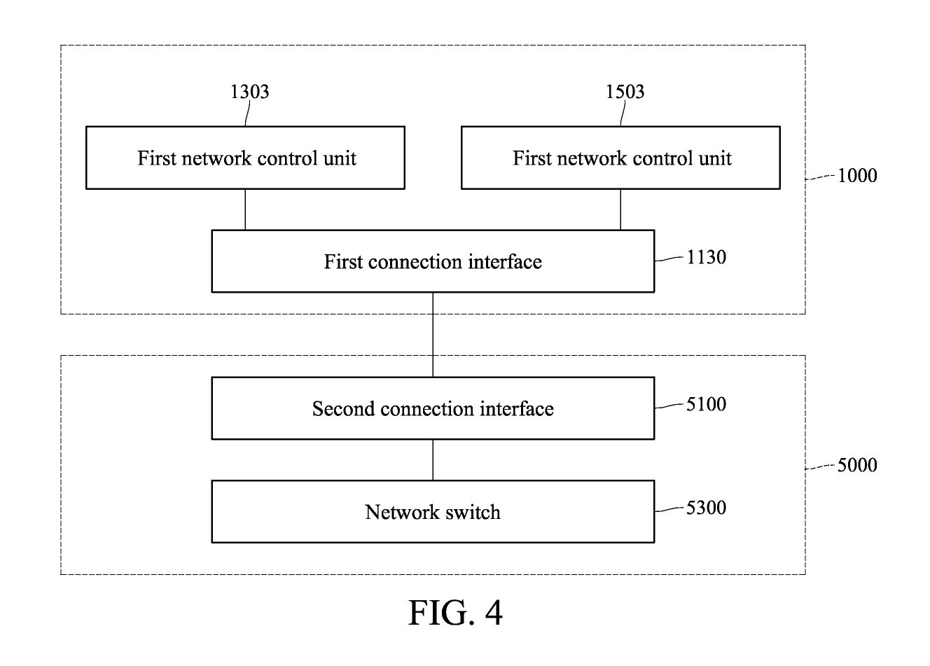

Please refer to FIG. 4. FIG. 4 is a functional block diagram of the electronic device according to an embodiment of the present invention. As shown in FIG. 4, the electronic device according to an embodiment of the present disclosure further includes a network switch 5300, and the first network control units 1303 and 1503 are electrically connected to the base board 5000 through the first connection interface 1130 and the second connection interface 5100 for communicating with the network switch 5300 electrically connected to the base board 5000.

In an embodiment, the computer board includes at least one PCI-E slot and the PCI-E slot is electrically connected to the first SOC and/or the second SOC respectively. In addition, the computer board further includes at least one stacked slot electrically connected to the first SOC and/or the second SOC, and the memory module is inserted to the stacked slot in a stack approach.

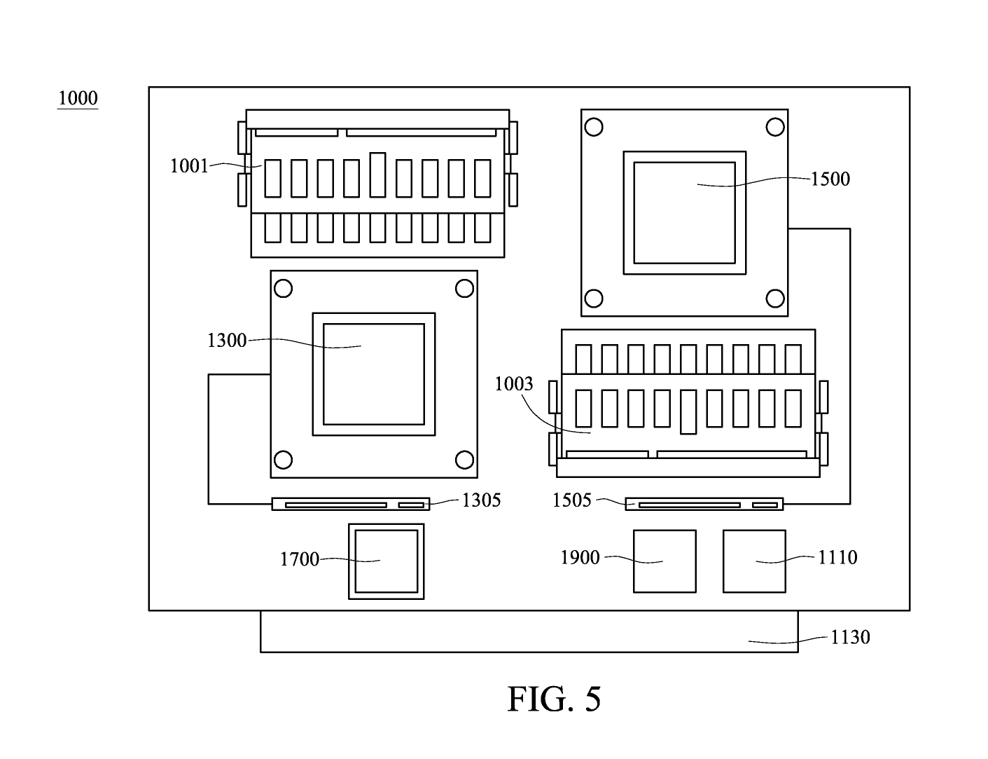

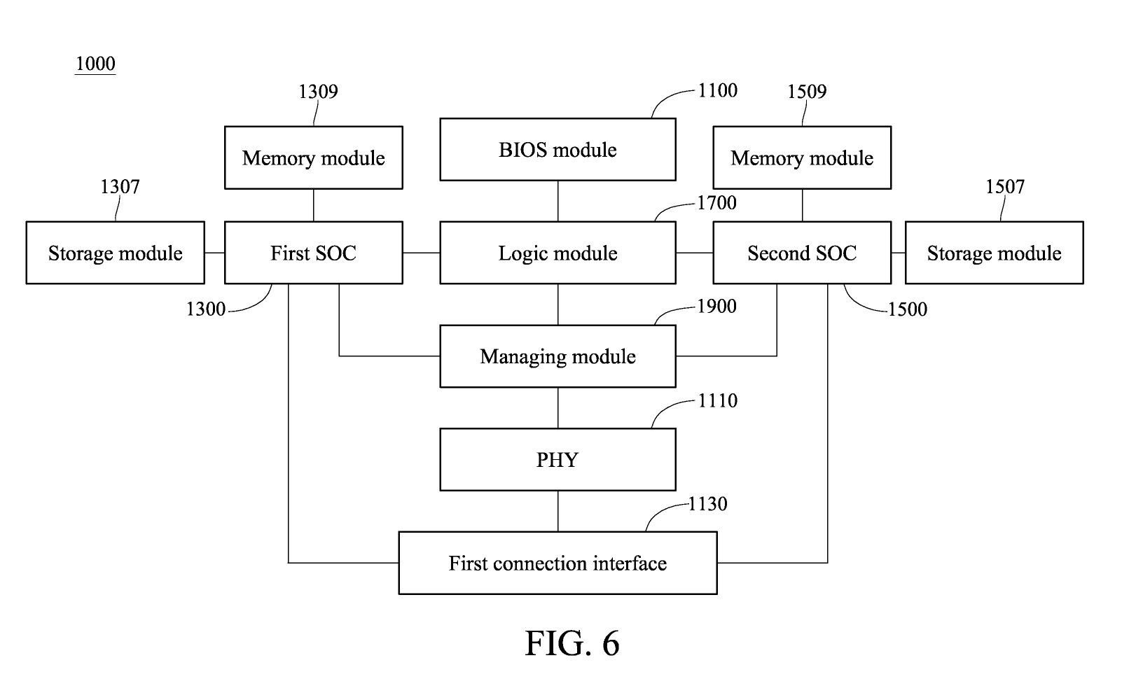

For example, please refer to FIG. 5 and FIG. 6. FIG. 5 is a layout diagram of the computer board according to an embodiment of the present invention. FIG. 6 is a functional block diagram of the computer board according to another embodiment of the present invention. As shown in FIG. 5 and FIG. 6, the layout of the computer board 1000 includes the first SOC 1300, the second SOC 1500, the logic module 1700, the managing module 1900, the PHY 1110, and the first connection interface 1130. In addition, the computer board 1000 further includes two PCI-E slots 1305 and 1505 and two stacked slots 1001 and 1003.

The PCI-E slot 1305 and the stacked slot 1001 are electrically connected to the first SOC 1300, and the PCI-E slot 1505 and the stacked slot 1003 are electrically connected to the second SOC 1500. Therefore, the first SOC 1300 and the second SOC 1500 are able to transfer data through the storage module 1307 and 1507 inserted in the PCI-E slot 1305 and 1505. In addition, the first SOC 1300 and the second SOC 1500 are able to perform data storage through the memory module 1309 and 1509 inserted in the stacked slot 1001 and 1003.

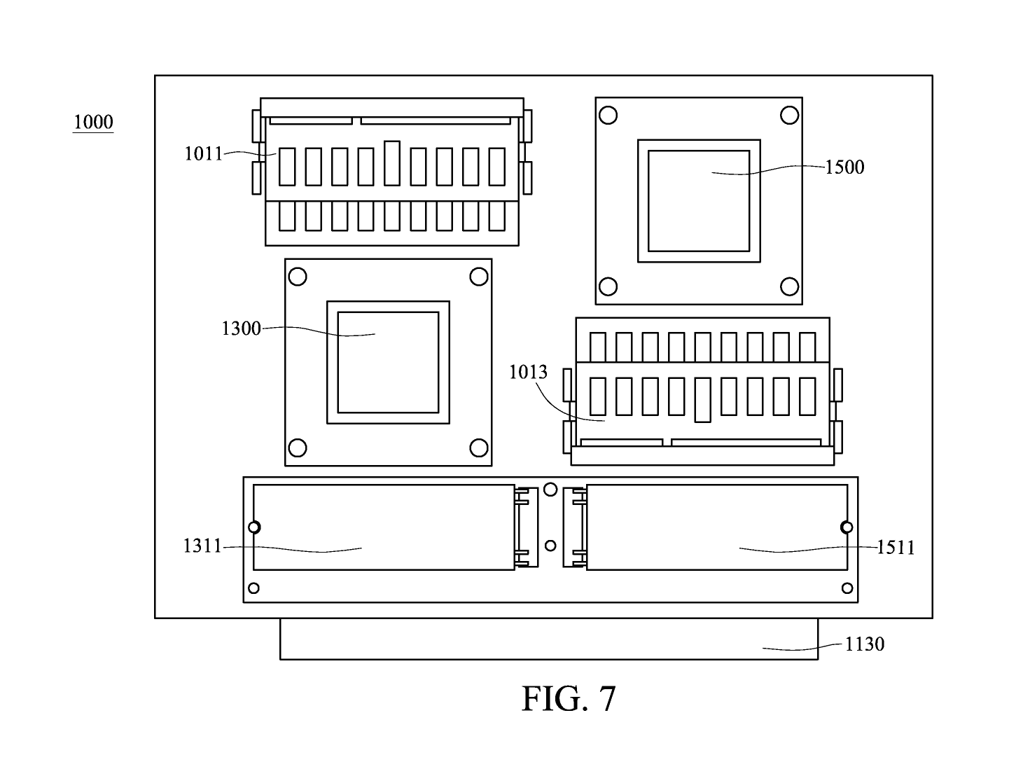

In an embodiment, the electronic device further includes at least one Next Generation Form Factor (NGFF) card, wherein the NGFF card has at least one solid state disk. Please refer to FIG. 7. FIG. 7 is a diagram of the electronic device according to an embodiment of the present invention. As shown in FIG. 7, the NGFF cards 1311 and 1511 are electrically connected to the first SOC 1300 and/or the second SOC 1500 through the PCI-E slot for data storage. In addition, the two stacked slot are inserted with the DDR3 memories 1011 and 1013, so the first SOC 1300 and/or the second SOC 1500 are able to perform data storage during processing.

The electronic device according to an embodiment of the present disclosure is for a micro server, and the electronic device includes a plurality of computer boards connected to a base board. Each of the plurality of computer boards includes a BIOS module, a first SOC, a second SOC, a logic module, a managing module, a PHY, and a first connection interface. The parallel computing ability of the low power processors adopted by the electronic device of the present disclosure is effective to normal server, and the power consumption and the cooling resources are reduced accordingly.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. An electronic device for a micro server, comprising:
a plurality of computer boards electrically connected to a base board, each of the plurality of computer boards comprising:
a Basic Input/Output System (BIOS) module for storing a BIOS;
a first System on Chip (SOC) for computing data;
a second SOC for computing data;
a logic module electrically connected to the first SOC, the second SOC, and the BIOS module respectively, for controlling the first SOC and the second SOC;
a managing module electrically connected to the logic module, the first SOC, and the second SOC respectively, the managing module obtaining an operation status message of the first SOC and/or the second SOC and managing the computer board through the logic module, the first SOC, and the second SOC;
a Port Physical Layer (PHY) electrically connected to the managing module, for transferring internet data; and
a first connection interface electrically connected to the first SOC, the second SOC, and a network chip respectively, for transferring data;
wherein when the computer board is booting, the logic module controls the first SOC to read the BIOS in the BIOS module to boot, and the first SOC sends a booting-finished message to the logic module after booting, and the logic module controls the second SOC to read the BIOS in the BIOS module to boot, and the second SOC sends a booting-finished message to the logic module after booting.

2. The device of claim 1, wherein the plurality of computer boards receive a booting command from the base board to boot, and the booting command is from a boot button electrically connected to the base board.

3. The device of claim 1, wherein the computer board receives a booting command from the base board to boot, and the computer board is booted by the booting command send from a client software through Internet, and the first SOC and the second SOC are activated individually.

4. The device of claim 1, wherein the first SOC and the second SOC are further respectively electrically connected to at least one storage module and at least one memory module.

5. The device of claim 4, wherein the computer board comprises at least one Peripheral Component Interconnect Express (PCI-E) slot and the at least one PCI-E slot is electrically connected to the first SOC and/or the second SOC.

6. The device of claim 5, further comprising at least one Next Generation Form Factor (NGFF) card, wherein the NGFF card has at least one solid state disk, and the at least one NGFF card is electrically connected to the first SOC and/or the second SOC through the PCI-E slot for data storage.

7. The device of claim 4, wherein each of the plurality of computer boards further comprises at least one stacked slot electrically connected to the first SOC and/or the second SOC respectively, and the memory module is inserted to the stacked slot in a stack approach.

8. The device of claim 4, wherein the at least one storage module is a hard disk supporting Serial Advanced Technology Attachment (SATA) or PCI-E.

9. The device of claim 1, wherein the first SOC comprises a Platform Controller Hub (PCH) and at least one first network control unit and the second SOC comprises a PCH and at least one first network control unit.

10. The device of claim 1, wherein the managing module comprises a second network control unit and the managing module is electrically connected to the PHY through the second network control unit for communicating with a remote management control module.

11. The device of claim 1, wherein the base board has a plurality of second connection interfaces, and the first connection interface matches one of the plurality of second connection interfaces, and each of the plurality of computer boards is electrically connected to the base board through the first connection interface and the plurality of second connection interfaces.

12. The device of claim 11, further comprising a network switch, wherein a first network control unit is electrically connected to the base board through the first connection interface and the plurality of second connection interfaces for communicating with the network switch electrically connected to the base board.

13. The device of claim 1, wherein the logic module is electrically connected to a non-volatile memory, and the first SOC and the second SOC share the non-volatile memory through the logic module.

14. The device of claim 1, wherein the first SOC and the second SOC are respectively electrically connected to the logic module through Low pin count bus (LPC bus), Serial Peripheral Interface (SPI), and General Purpose Input Output (GPIO) to exchange information and control commands.

15. The device of claim 1, wherein the managing module is electrically connected to the first SOC and the second SOC through an Inter-Integrated Circuit (IIC).

16. The device of claim 1, wherein the managing module is electrically connected to the logic module through input/output (I/O), SPI, and Universal Asynchronous Receiver/Transmitter (UART).

17. The device of claim 1, wherein the BIOS module is a Read-only Memory (ROM).

18. The device of claim 1, wherein the logic module is a complex programmable logic device (CPLD).

19. The device of claim 1, wherein the first SOC and the second SOC are SOCs capable of computing.

20. The device of claim 1, wherein the managing module is a Cartridge Micro-Controller.
